(19) United States
(12) Patent Application Publication
(10) Pub. No.: US 2024/0411763 A1
(43) Pub. Date: Dec. 12, 2024

(54) PREVENTING TRANSMISSION OF INVALID OR NON-COMPLIANT TRANSACTION DATA TO OTHER ENTITIES

(71) Applicant: WELLS FARGO BANK, N.A., San Francisco, CA (US)

(72) Inventors: Ronald T. Blum, Des Moines, IA (US); Thanigaivasan Chinnasamy, Charlotte, NC (US); Prashanth Sravan Kumar Erpula, Hyderabad (IN); Ashish Chauhan, Hyderabad (IN); Cory Patrick, Chandler, AZ (US); Parijat Mukherjee, Hyderabad (IN); Troy Wise, Charlotte, NC (US)

(21) Appl. No.: 18/330,485

(22) Filed: Jun. 7, 2023

(51) Int. Cl. G06F 16/2455; G06Q 20/38

(52) U.S. Cl. CPC G06F 16/24564; G06Q 20/389

(57) ABSTRACT

Methods and systems disclosed herein relate to preventing transmission of invalid or non-compliant transaction data to other entities. A data-furnishing application accesses first transaction data associated with a first account of a first user. The data-furnishing application applies a plurality of data-processing rules to the first transaction data to determine whether the first transaction data is to be suppressed or furnished to another entity. The data-furnishing application determines, based on outputs generated by applying the plurality of data-processing rules, that the first transaction data violates a first condition associated with a first data-processing rule of the third rule category while satisfying a second condition associated with a second data-processing rule of the second rule category. The data-furnishing application generates a first report that excludes the first transaction data in response to determining that the first transaction data violates the first condition.

### TECHNICAL FIELD

This disclosure generally relates to preventing transmission of invalid or non-compliant transaction data to other entities. More specifically, but not by way of limitation, this disclosure relates to using a set of hierarchical data-processing rules to increase efficiency of identifying and suppressing invalid or non-compliant transaction data.

### BACKGROUND

Entities routinely provide reports for data-collection agencies for various purposes. For example, transaction data identifying an individual's credit and debit transactions can be recorded and reported to a data-collection agency, at which the data-collection agency can analyze the transaction data to generate a score that reflects the individual's creditworthiness. Conventional techniques can include implementing different platforms to streamline certain data-collection and formatting functions, such as generating a system-of-record (SOR) file that include transaction data corresponding to different user accounts associated with the entity and generating a report of the transaction data that is eventually furnished to the data-collection agencies.

In some instances, there are situations in which reporting transaction data of the individual should be avoided. For example, the transaction data can include information that compromise the individual's data security and privacy. Transmitting the transaction data with such information may result in failing to comply with rules and regulations established by various government agencies. Conventional techniques address this problem by manually reviewing each transaction data of the SOR file. The manual review can include identifying rules that may be applicable to the transaction data, comparing the identified rules to the transaction data, and removing the information prior to furnishing the transaction data to the data-collection agencies. However, these techniques can be cumbersome and challenging when the entities are required to provide reports on a large number of individuals (e.g., more than a thousand).

### SUMMARY

Certain embodiments involve preventing transmission of invalid or non-compliant transaction data to other entities. A data-furnishing application accesses first transaction data of a system-of-record (SOR) file associated with an entity. The first transaction data is associated with a first account of a first user. The data-furnishing application applies a plurality of data-processing rules to the first transaction data to determine whether the first transaction data is to be suppressed or furnished to another entity. In some instances, each data-processing rule of the plurality of data-processing rules is associated with a rule condition and a particular rule category of a set of rule categories. The set of rule categories can include: (i) a first rule category configured to be applicable to a plurality of accounts associated with the entity; (ii) a second rule category configured to be applicable to a subset of accounts of the plurality of accounts; and (iii) a third rule category configured to be applicable to a single account of the plurality of accounts. In some instances, an output generated by applying a data-processing rule of the third rule category overrides other outputs generated by applying other data-processing rules of the first and second rule categories.

The data-furnishing application determines, based on a set of outputs generated by applying the plurality of data-processing rules, that the first transaction data violates a first condition associated with a first data-processing rule of the third rule category while satisfying a second condition associated with a second data-processing rule of the second rule category. The data-furnishing application generates a first report that excludes the first transaction data in response to determining that the first transaction data violates the first condition of the first data-processing rule. The data-furnishing application outputs the first report. As a result, the data-furnishing application suppresses the first transaction data from being furnished to the other entity, which prevent transmission of non-compliant data.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example schematic diagram for preventing transmission of invalid or non-compliant transaction data to other entities, in accordance with some embodiments.

FIG. 2 illustrates a computing environment for preventing transmission of invalid or non-compliant transaction data to other entities, in accordance with some embodiments.

FIG. 3 illustrates a process for preventing transmission of invalid or non-compliant transaction data to other entities, in accordance with some embodiments.

FIG. 4 depicts an example decision matrix for determining whether to furnish or suppress the transaction data, according to some embodiments.

FIG. 5 illustrates a process for applying hierarchical data-processing rules to transaction data, in accordance with some embodiments.

FIG. 6 depicts a computing system configured for preventing transmission of invalid or non-compliant transaction data to other entities, in accordance with some embodiments.

### DETAILED DESCRIPTION

Conventional techniques for reporting transaction data include manually reviewing each transaction data of the SOR file. In particular, the manual review includes identifying rules that may be applicable to a transaction data, comparing the identified rules to the transaction data, and removing the information prior to furnishing the transaction data to the data-collection agencies. If the transaction data includes invalid or non-compliant information, conventional techniques can “suppress” the transaction data from being furnished until the information is modified or removed. However, these techniques can be cumbersome and challenging when the entities are required to provide reports on a large number of individuals (e.g., more than a thousand).

Certain embodiments described herein can address these problems by preventing transmission of invalid or non-compliant transaction data to other entities. Transaction data (e.g., purchase history) of a user may include information that may result in non-compliance of regulations set forth by government agencies when transmitted to other entities. Rather than manually reviewing each and every transaction data, certain embodiments of the present disclosure can implement a process for increasing efficiency of identifying transaction data that requires intervention, while allowing other transaction data to be automatically remediated and transmitted even when it may be initially listed as non-compliant. Certain embodiments can also include a process for determining a furnish or suppress decision of transaction data by applying data-processing rules associated with different rule hierarchies (e.g., Rule ID, Error Notes, Account Level).

A data-furnishing application accesses first transaction data of a system-of-record (SOR) file associated with an entity. The first transaction data is associated with a first account of a first user. As an illustrative example, the SOR file includes transaction data corresponding to purchase and loan transactions that a user has performed over a given time period (e.g., February). The first transaction data of the first user can include information that may be non-compliant with one or more regulations established by the government agencies. In some instances, the first transaction data of the first user can be preprocessed by a data-quality scanner to identify and remove any invalid data that may trigger errors.

The data-furnishing application applies a plurality of data-processing rules to the first transaction data to determine whether the first transaction data is to be suppressed or furnished to another entity (e.g., a data-collection agency). In some instances, each data-processing rule of the plurality of data-processing rules is associated with a rule condition and a particular rule category of a set of rule categories. The set of rule categories can include: (i) a first rule category configured to be applicable to a plurality of accounts associated with the entity; (ii) a second rule category configured to be applicable to a subset of accounts of the plurality of accounts; and (iii) a third rule category configured to be applicable to a single account of the plurality of accounts. In some instances, an output generated by applying a data-processing rule of the third rule category overrides other outputs generated by applying other data-processing rules of the first and second rule categories.

Continuing with the example, the data-furnishing application identifies a first set of data-processing rules that are specific to the user-account level (e.g., the third rule category, Account Level), a second set of data-processing rules that are specific to discrepancies identified from the transaction data of the user (e.g., the second rule category, Error-Notes Level), and a third set of data-processing rules that generally apply to all accounts associated with the entity (e.g., the first rule category, Rule ID Level). A violation of a data-processing rule may result in violating the privacy regulations set forth by the data-collection agencies.

The data-furnishing application determines, based on a set of outputs generated by applying the plurality of data-processing rules, that the first transaction data violates a first condition associated with a first data-processing rule of the third rule category while satisfying a second condition associated with a second data-processing rule of the second rule category. Continuing with the example, the purchase and loan transactions of the transaction data include address of the user's residence that may result in potentially violating privacy regulations set forth by the data-collection agencies. The data-furnishing application determines that the transaction data fails the Account Level rule by including the address of the user's residence, but also determines that the transaction data satisfies the Rule ID level requiring omission of the social security number of the user. Continuing with the example, the data-furnishing application can determine that the transaction data of the user should be suppressed, as the Account Level rule takes precedence over rules that belong to the remaining rule categories.

The data-furnishing application generates a first report that excludes the first transaction data in response to determining that the first transaction data violates the first condition of the first data-processing rule. Continuing with the example, the data-furnishing application generates a credit report for the accounts identified by the entity, in which the credit report excludes that transaction data of the user as it has been suppressed by the data-furnishing application.

The data-furnishing application outputs the first report. The first report can be transmitted to the other entity, such as one or more of the data-collection agencies. Continuing with the example, the data-furnishing application transmits the credit report, while flagging the transaction data of the user to be modified by an agent. Once the agent removes the address of the user's residence, the data-furnishing application may generate another credit report that includes the modified transaction data to the data-collection agencies.

Certain embodiments described herein also include a data processing system that eliminates or reduces the amount of user interaction required to verify that information is in compliance with industry rules. As one example, an organization may collect customer data associated with, e.g., new accounts. Collected data includes information like name, address, and specific information regarding customer requests. Each of these various pieces of information must be checked for compliance with rules, e.g., a rule may be that the last name must comprise two or more letters. Under current systems, if any of the data is faulty, it is output to an Excel spreadsheet that must be manually reconciled to confirm whether the data is accurate. Certain embodiments described herein solve this problem by automating the process of comparing data to rules.

Certain embodiments described herein are directed to an improvement from conventional techniques that manually review transaction data associated with a large number of user accounts of the entity. For example, rather than manually generating a spreadsheet of the transaction data and review each row for compliance of government regulations, certain embodiments can automatically identify invalid or non-compliant transaction data that should be remediated before furnishing it to the other entities. The use of hierarchical data-processing rules can also facilitate reduction of false positives in which some transaction data may be initially identified as being non-compliant and suppressed. For example, satisfaction of the user-account specific rule can override or supersede other corresponding data-processing rules that apply to all accounts of the entity. As a result, certain embodiments can reduce the risk of the entity transmitting invalid or non-compliant transaction data to other entities, while using a set of hierarchical data-processing rules to increase efficiency of identifying and suppressing invalid or non-compliant transaction data.

### I. Overview

As explained above, transaction data (e.g., purchase history) of a user may include information that may result in non-compliance of regulations set forth by government agencies when transmitted to other entities. Rather than manually reviewing each and every transaction data, a data-furnishing application can automatically identify transaction data that requires intervention. The efficiency of identifying invalid and non-compliant transaction data can be improved by applying data-processing rules associated with different rule hierarchies (e.g., Rule ID, Error Notes, Account Level). As a result, rather than manually generating a spreadsheet of the transaction data and review each row for compliance of government regulations, the data-furnishing application can automatically identify invalid or non-compliant transaction data that should be remediated before furnishing it to the other entities.

### A. Example Schematic Diagram

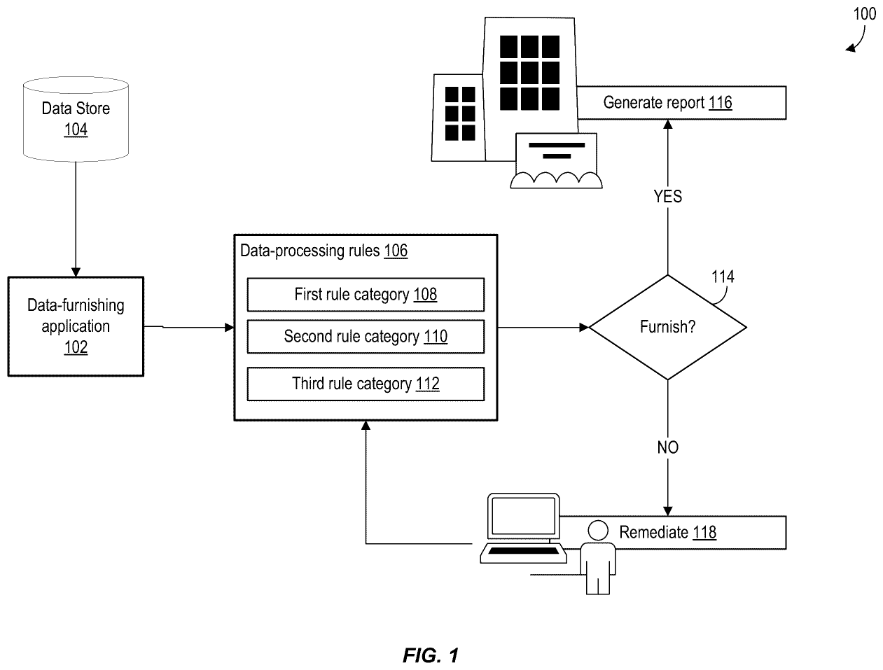

FIG. 1 illustrates an example schematic diagram 100 for preventing transmission of invalid or non-compliant transaction data to other entities, in accordance with some embodiments. In FIG. 1, a data-furnishing application 102 accesses transaction data of a system-of-record (SOR) file associated with an entity. In some instances, the data-furnishing application 102 accesses the SOR file from a data store 104 (e.g., a central data repository, a SOR database). The transaction data is associated with an account of a user and can correspond to a particular portion (e.g., a row) of the SOR file. The SOR file can be generated in a file format (e.g., a Metro 2 file format) specified by the data-collection agencies. The transaction data can correspond to credit and debit transactions of the user has performed over a given time period (e.g., February). The transaction data of the user can include information that may be invalid or non-compliant with one or more regulations established by the government agencies. In some instances, the transaction data can be preprocessed by a data-quality scanner to identify and remove any invalid data that may trigger errors. Additionally or alternatively, the data-furnishing application can assign a priority level (e.g., a severity level) to the transaction data, at which the review of the transaction data can be expedited (e.g., place in front of a queue) or delayed in accordance with the assigned priority level.

The data-furnishing application 102 applies a plurality of data-processing rules 106 to the transaction data to determine whether the transaction data is to be suppressed or furnished to another entity (e.g., a data-collection agency). In some instances, each data-processing rule of the plurality of data-processing rules is associated with a rule condition and a particular rule category of a set of rule categories. The set of rule categories can include: (i) a first rule category 108 configured to be applicable to a plurality of accounts associated with the entity; (ii) a second rule category 110 configured to be applicable to a subset of accounts of the plurality of accounts; and (iii) a third rule category 112 configured to be applicable to a single account of the plurality of accounts. For example, the data-processing rules of the third rule category 112 are the Account Level rules, which applies specifically to the user account. The data-processing rules of the second rule category 110 are Error Notes rules, which are specific to discrepancies identified from the transaction data of the user. The data-processing rules of the first rule category 108 correspond to Rule ID Level rules, which generally apply to all accounts associated with the entity. The rules of the third rule category 112 take precedence over rules of the first and second rule categories 108 and 110, such that the output (e.g., a “Furnish” decision) generated by applying the rule of the third rule category 112 overrides the outputs (e.g., “Suppress” decisions) generated by applying rules of the first and second rule categories 108 and 110.

At decision block 114, the data-furnishing application 102 determines whether to furnish or suppress the transaction data based on outputs generated by applying the data-processing rules 106. For example, the data-furnishing application 102 can generate a report and furnish the report to a data-collection agency (block 116), in response to determining that the transaction data satisfies all conditions associated with the data-processing rules. In some instances, the data-furnishing application 102 generates and furnishes the report to the data-collection agency, if the output from applying the Account Level rule (e.g., third rule category 112) indicates a “Furnish” decision (regardless of outputs from rules of other rule categories).

If the data-furnishing application 102 determines that the transaction data should be suppressed, the data-furnishing application 102 transmits the transaction data for remedial action (block 116). The remedial action 116 can include modifying or removing information that triggered the violation of one or more conditions of the data-processing rules. In some instances, once the transaction data has been modified, the data-furnishing application 102 applies the data-processing rules again to determine whether to furnish the modified transaction data to the data-collection agency.

In some instances, the data-furnishing application 102 generates and furnishes a report that excludes the transaction data, while the transaction data is being suppressed and remediated. The data-furnishing application 102 can determine whether to furnish or suppress the transaction data based on the hierarchy levels of the data-processing rules. For example, the data-furnishing application 102 determines that the transaction data violates a first condition associated with a first data-processing rule of the third rule category (e.g., Account Level) while satisfying a second condition associated with a second data-processing rule of the second rule category (e.g., Error Notes). In this case, the data-furnishing application 102 can determine that the transaction data of the user should be suppressed, as the Account Level rule takes precedence over rules that belong to the remaining rule categories.

### B. Example Computing Environment

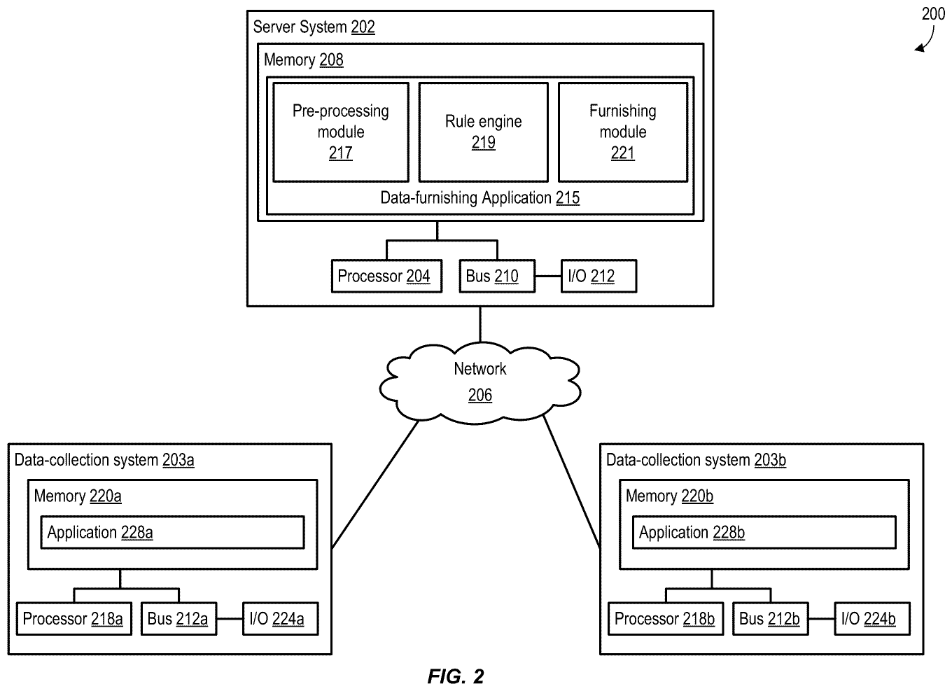

FIG. 2 illustrates a computing environment 200 for preventing transmission of invalid or non-compliant transaction data to other entities, in accordance with some embodiments. The computing systems in this example include a server system 202 and data-collection systems 203a and 203b in communication via a network 206.

The server system 202 includes a processor 204 that is communicatively coupled to a memory 208 and that executes computer-executable program instructions and/or accesses information stored in the memory 208. The processor 204 may include a microprocessor, an application-specific integrated circuit (“ASIC”), a state machine, or other suitable processing device. The processor 204 can include any of a number of computer processing devices, including one. Such a processor can include or may be in communication with a computer-readable medium storing instructions that, when executed by the processor 204, cause the processor to perform the steps described herein.

A data-furnishing application 215 stored in the memory 208 of the server system 202 can configure the processor 204 to provide transaction-reports for one of data-collection systems 203a-b. The data-furnishing application 215 can configure the processor 204 to access the SOR file stored in the memory 208, identify the transaction data from the SOR file, apply data-processing rules to the transaction data, and generate an output indicative of whether the transaction data should be furnished or suppressed from being transmitted to the data-collection systems 203a-b that are operated by one or more other entities (e.g., data-collection agencies). The data-furnishing application 215 may additionally provide a social media service, a cloud service, or other network service that can be accessed by the data-collection systems 203a-b. A cloud service can include a collection of computing resources, including computing systems and/or applications, that can be provided as an online service via a data network. The collection of computing systems and/or hardware can be represented as a single service. The cloud service can provide a digital hub for browsing, creating, sharing, and otherwise using electronic content using one or more applications provided via the cloud service.

The data-furnishing application 215 stored in the server system 202 is configured to prevent transmission of non-compliant transaction data to other entities. Transaction data (e.g., purchase history) of a user may include information that may result in non-compliance of regulations set forth by government agencies when transmitted to other entities. The data-furnishing application 102 can identify transaction data that requires intervention, while allowing other transaction data to be automatically remediated and transmitted even when it may be initially listed as non-compliant. In some instances, the data-furnishing application 215 also determines a furnish or suppress decision of transaction data by applying data-processing rules associated with different rule hierarchies (e.g., Rule ID, Error Notes, Account Level).

In some instances, the data-furnishing application 215 includes the following modules to prevent transmission of non-compliant transaction data to other entities: (i) a pre-processing module 217 for removing invalid data from transaction data and assigning priority levels to the transaction data before the transaction data is processed by a rules engine 219; (ii) the rules engine 219 for identifying and applying data-processing rules to the transaction data to generate an output; and (iii) a furnishing module 221 for processing outputs of the rules engine 219 to determine whether the transaction data should be furnished or suppressed. The above modules can be used individually or in different combinations to allow the data-furnishing application 215 to determine whether to furnish or suppress the transaction data associated with the user.

The pre-processing module 217 accesses an SOR file generated by an entity. The pre-processing module 217 can parse the transaction data of the SOR file to determine whether the transaction data includes any invalid data. For example, the invalid data may include numerical values that exceed a predefined range for a particular field of the transaction data, values (e.g., alphabet characters) inputted in a format that is different from the predefined format required for the particular field, or omitted data on fields that are required to be inputted (e.g., name of the user). In some instances, the pre-processing module 217 assigns a priority level (e.g., a severity level) to the transaction data of the SOR file, at which the review of the transaction data can be expedited (e.g., place in front of a queue) or delayed in accordance with the assigned priority level.

In some instances, the rules engine 219 applies a plurality of data-processing rules to the transaction data provided by the pre-processing module 217 to determine whether the transaction data is to be suppressed or furnished to another entity (e.g., a data-collection agency). In some instances, each data-processing rule of the plurality of data-processing rules is associated with a rule condition and a particular rule category of a set of rule categories. The set of rule categories can include: (i) a first rule category configured to be applicable to a plurality of accounts associated with the entity; (ii) a second rule category configured to be applicable to a subset of accounts of the plurality of accounts; and (iii) a third rule category configured to be applicable to a single account of the plurality of accounts. The rules of the third rule category take precedence over rules of the first and second rule categories, such that the output (e.g., a “Furnish” decision) generated by applying the rule of the third rule category overrides the outputs (e.g., “Suppress” decisions) generated by applying rules of the first and second rule categories.

The furnishing module 221 can be configured to process outputs of the rules engine 219 to determine whether the transaction data should be furnished or suppressed. In some instances, the rules engine 219 generates a report and furnish the report to a data-collection agency, in response to determining that the transaction data satisfies all conditions associated with the data-processing rules. In some instances, the furnishing module 221 furnishes the report to the data-collection agency, if the output generated from applying a data-processing rule third rule category indicates a “Furnish” decision. The furnish decision would be performed regardless of outputs from rules of other rule categories, as the data-processing rules of the third rule category would take precedence over the rules from the first and second rule categories.

If it is determined that the transaction data should be suppressed, the furnishing module 221 suppresses and/or transmits the transaction data for remedial action. The remedial action can include modifying or removing information that triggered the violation of one or more conditions of the data-processing rules. In some instances, once the transaction data has been modified, the rules-engine 219 applies the data-processing rules again to determine whether to furnish the modified transaction data to the data-collection agency.

Referring back to FIG. 2, the server system 202 may also include a number of external or internal devices, such as input or output devices. For example, the server system 202 is shown with an input/output (“I/O”) interface 212. A bus 210 can also be included in the server system 202. The bus 210 can communicatively couple one or more components of the server system 202. The server system 202 can include any suitable computing system for hosting the data-furnishing application 215. In one embodiment, the server system 202 may be a single computing system. In another embodiment, the server system 202 may be a virtual server implemented using a number of computing systems connected in a grid or cloud computing topology.

Each of the data-collection systems 203a and/or 203b includes a computer-readable medium, such as processors 218a and/or 218b, respectively. Each of the processors 218a and/or 218b is communicatively coupled to a memory 220a and/or 220b, respectively. Each of the processors 218a and/or 218b respectively executes computer-executable program instructions and/or accesses information stored in the memory 220a and/or 220b. Each of the processors 218a and/or 218b may include a microprocessor, an ASIC, a state machine, or other processor. Each of the processors 218a and/or 218b can include any of a number of computer processing devices, including one. Such a processor can include or may be in communication with a computer-readable medium. The computer-readable medium stores instructions that when executed by the processor, cause the processor to perform the steps described herein.

The data-collection systems 203a and/or 203b may also include a number of external or internal devices, such as a display, audio speakers, one or more microphones, or any other input or output devices. For example, each of the data-collection systems 203a and/or 203b is respectively shown with input/output (“I/O”) interfaces 224a, 224b and display devices 226a, 226b. Buses can be respectively included in the data-collection systems 203a and/or 203b. Each of the buses can communicatively couple one or more components of the data-collection systems 203a and/or 203b.

FIG. 2 also illustrates the applications 228a and/or 228b respectively included in the memory 220a and/or 220b of the data-collection systems 203a and/or 203b. Each of the applications 228a and/or 228b can include one or more software modules. The applications 228a and/or 228b can respectively configure the processors 218a and/or 218b to modify or otherwise access the transaction data from the reports provided by the server system 202 via the network 206. The applications 228a and/or 228b can respectively configure the processors 218a and/or 218b to respectively register the data-collection systems 203a and/or 203b with the data-furnishing application 215 over the network 206. For example, each of the applications 228a and/or 228b includes a user interface that allows a user to establish a network session between the data-collection systems 203a and/or 203b and the server system 202 via the network 206.

In some embodiments, the data-collection systems 203a and/or 203b can be connected to any suitable client devices for communicating via a network 206 and executing the applications 228a and/or 228b. Non-limiting examples of a computing device include a desktop computer, a tablet computer, a smart phone, or any other computing device suitable for using electronic content. In other embodiments, the data-collection systems 203a and/or 203b include server systems for providing electronic content items via the applications 228a and/or 228b.

### C. Process for Preventing Transmission of Invalid or Non-compliant Transaction Data to Other Entities

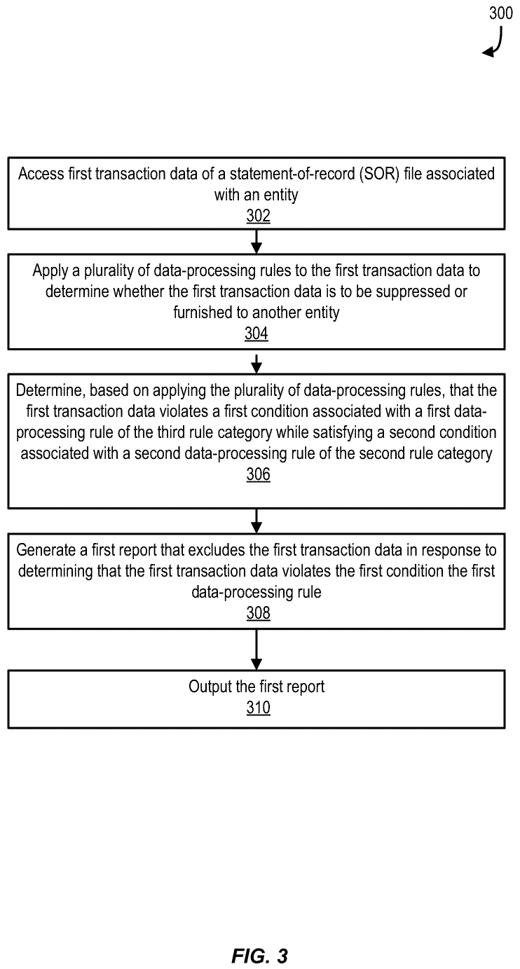

FIG. 3 illustrates a process 300 for preventing transmission of invalid or non-compliant transaction data to other entities, in accordance with some embodiments. For illustrative purposes, the process 300 is described with reference to the components illustrated in FIG. 1, though other implementations are possible. For example, the program code for the data-furnishing application 102 of FIG. 1, which is stored in a non-transitory computer-readable medium, is executed by one or more processing devices to cause a server system to perform one or more operations described herein.

At step 302, a data-furnishing application accesses first transaction data of a system-of-record (SOR) file associated with an entity. For example, the SOR file can be associated with a corporate entity obligated to furnish credit reports to data-collection agencies (e.g., Experian®, Equifax®). The first transaction data is associated with a first account of a first user.

At step 304, the data-furnishing application applies a plurality of data-processing rules to the first transaction data to determine whether the first transaction data is to be suppressed or furnished to another entity (e.g., a data-collection agency). In some instances, each data-processing rule of the plurality of data-processing rules is associated with a rule condition and a particular rule category of a set of rule categories. The set of rule categories can include: (i) a first rule category configured to be applicable to a plurality of accounts associated with the entity; (ii) a second rule category configured to be applicable to a subset of accounts of the plurality of accounts; and (iii) a third rule category configured to be applicable to a single account of the plurality of accounts. In some instances, an output generated by applying a data-processing rule of the third rule category (e.g., account level) overrides other outputs generated by applying other data-processing rules of the first and second rule categories (e.g., Rule ID, Error Notes).

In some instances, applying the plurality of data-processing rules to the first transaction data includes the data-furnishing application determining whether the plurality of data-processing rules include one or more data-processing rules associated with the third rule category. If the one or more data-processing rules exist, the data-furnishing application applies the one or more data-processing rules prior while disregarding the remaining data-processing rules of the plurality of data-processing rules. Applying the data-processing rules of the account-level category first can increase the efficiency of data-furnishing process by disregarding the other rules that would eventually be overridden.

If it is determined that the plurality of data-processing rules do not include the one or more data-processing rules and include data-processing rules associated with the first and second rule categories, the data-furnishing application: (i) accesses a decision matrix that represents the plurality of data-processing rules; and (ii) iteratively applies each of the plurality of data-processing rules of the decision matrix to the first transaction data to determine whether to suppress or furnish the first transaction data to the other entity.

At step 306, the data-furnishing application determines, based on a set of outputs generated by applying the plurality of data-processing rules, that the first transaction data violates a first condition associated with a first data-processing rule of the third rule category while satisfying a second condition associated with a second data-processing rule of the second rule category.

At step 308, the data-furnishing application generates a first report that excludes the first transaction data in response to determining that the first transaction data violates the first condition of the first data-processing rule.

At step 310, the data-furnishing application outputs the first report (e.g., a credit report). As a result, the data-furnishing application suppresses the first transaction data from being furnished to the other entity (e.g., the data-collection agencies), which prevent transmission of non-compliant data. Process 300 terminates thereafter.

In some instances, because the output from applying the third rule category (e.g., account level) overrides outputs of other rule categories (e.g., Rule ID, Error Notes), the satisfaction of a condition of a data-processing rule associated the third rule category takes precedence over violations of conditions of data-processing rules associated with first and second rule categories. As an illustrative example, the data-furnishing application accesses second transaction data of the SOR file. The second transaction data is associated with a second account of a second user. The data-furnishing application applies the plurality of data-processing rules to the second transaction data to determine whether the second transaction data is to be suppressed or furnished to the other entity. The data-furnishing application determines, based on a set of outputs generated by applying the plurality of data-processing rules, that the second transaction data satisfies the first condition of the first data-processing rule while violating the second condition of the second data-processing rule and a third condition of a third data-processing rule of a first rule category. In response to determining that the second transaction data satisfies the first condition of the first data-processing rule, data-furnishing application generates a second report that includes the second transaction data. The data-furnishing application outputs the second report, thereby furnishing the second transaction data to the other entity (e.g., the data-collection agencies).

If a data-processing rule associated with the third-rule category does not apply, a different decision process is applied as to whether transaction data should be suppressed or furnished. In particular, the violation of a condition of a data-processing rule associated the first rule category takes precedence over satisfaction of conditions of data-processing rules associated with the second rule category, and vice versa. As an illustrative example, the data-furnishing application accesses third transaction data of the SOR file. The third transaction data is associated with a third account of a third user. The data-furnishing application applies the plurality of data-processing rules to the third transaction data to determine whether the third transaction data is to be suppressed or furnished to the other entity. The data-furnishing application determines, based on a set of outputs generated by applying the plurality of data-processing rules, that the third transaction data satisfies the second condition of the second data-processing rule while violating a third condition associated with a third data-processing rule of a first rule category. In response to determining that the third transaction data violates the third data-processing rule, the data-furnishing application generates a third report that excludes the third transaction data. The data-furnishing application outputs the third report, thereby suppressing the third transaction data from being furnished to the other entity (e.g., the data-collection agencies).

### II. Furnishing or Suppressing Transaction Data Based on Outputs Generated from Applying Data-Processing Rules

As described herein, the data-furnishing application applies a plurality of data-processing rules to automatically determine whether to furnish or suppress the transaction data from reporting it to data-collection agencies. In some instances, each data-processing rule of the plurality of data-processing rules is associated with a rule condition and a particular rule category of a set of rule categories. The set of rule categories can include: (i) a first rule category configured to be applicable to a plurality of accounts associated with the entity; (ii) a second rule category configured to be applicable to a subset of accounts of the plurality of accounts; and (iii) a third rule category configured to be applicable to a single account of the plurality of accounts. In some instances, an output generated by applying a data-processing rule of the third rule category overrides other outputs generated by applying other data-processing rules of the first and second rule categories. The use of hierarchical data-processing rules facilitate reduction of false positives in which some transaction data may be initially identified as being non-compliant and suppressed.

### A. Decision Matrix

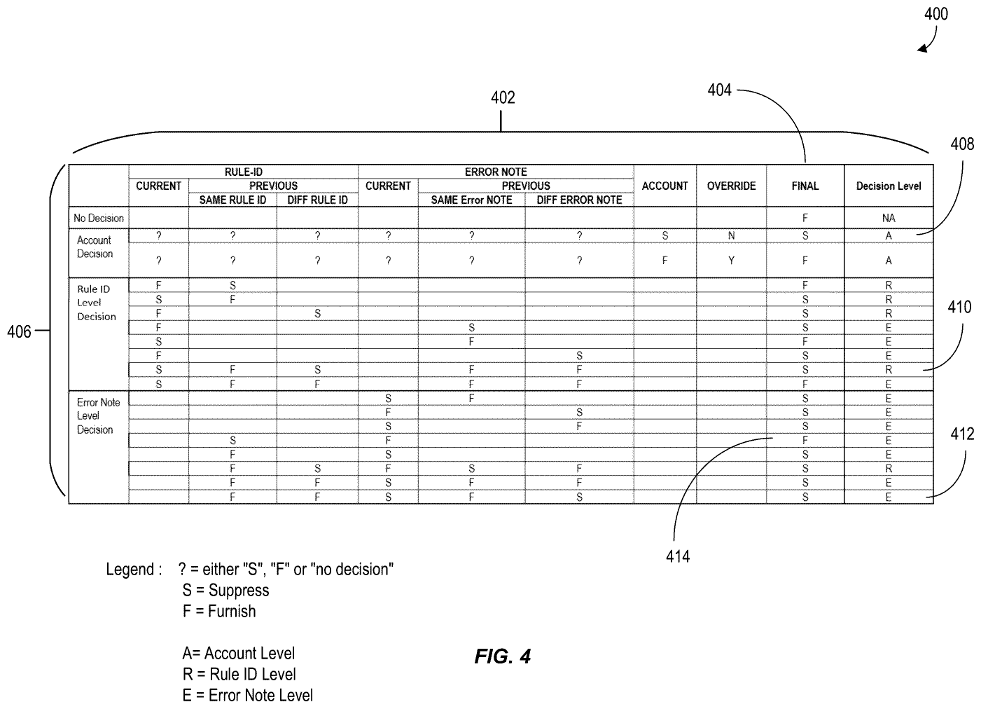

To further facilitate the decision process for determining whether to furnish or suppress transaction data, the data-furnishing application can implement one or more decision matrices. FIG. 4 depicts an example decision matrix 400 for determining whether to furnish or suppress the transaction data, according to some embodiments. The decision matrix 400 includes a set of columns 402, in which each column includes a rule category. For example, the set of columns 402 include one or more columns that correspond to a Rule ID category, in which the corresponding data-processing rules generally apply to all accounts associated with an entity (e.g., a financial institution). The set of columns 402 include one or more columns that correspond to an Error Notes category, which are specific to discrepancies identified from the transaction data of the user. The set of columns 402 also include one or more columns that correspond to Account Level category, which applies specifically to the user account. As described herein, the rules associated with the rules of Account Level category take precedence over rules of the Rule ID and Error Notes categories, such that the output (e.g., a “Furnish” decision) generated by applying the rule of the Account Level category overrides the outputs (e.g., “Suppress” decisions) generated by applying rules of the other rule categories.

The set of columns 402 can also include a column 404 that identifies a final decision (e.g., furnish, suppress) for the corresponding transaction data. In some instances, the set of columns 402 also identifies a rule category that was applicable for reaching the final decision. For example, the column 404 can identify a “S” decision, which corresponds to a suppress decision. The other column indicates that the “S” decision was reached based on applying one or more data-processing rules associated with the Account Level.

The decision matrix 400 also includes a set of rows 406, in which each row of the set of rows 406 identifies transaction data of a particular user. In some instances, two or more rows correspond to different transaction data associated with the same user. For transaction data of a given row, the data-furnishing application applies a plurality of data-processing rules to the transaction data to determine whether the transaction data is to be suppressed or furnished to another entity. The determination will be indicated at the decision column 404 of the decision matrix 400.

As an illustrative example, the data-furnishing application can determine that an Account-level rule applies to the transaction data identified in row 408 of the decision matrix 400. The data-furnishing application applies the Account-level rule to the transaction data to generate an output indicating that the transaction data fails to satisfy one or more conditions associated with the Account-level rule. As the rules associated with the rules of Account Level category take precedence over rules of the Rule ID and Error Notes categories, the data-furnishing application does not take further steps to identify rules from other rule categories and assigns the “S” decision to the transaction data of the row 408.

The data-furnishing application can apply a different decision logic when the no Account-rule can be identified for transaction data of a given row. In some instances, the data-furnishing application determines that the suppress “S” decision of the Rule ID or Error-Notes category will override the furnish “F” decision of the other rule category. For example, the data-furnishing application determines that no Account-level rules apply to the transaction data identified in row 410, but also determines that two Rule ID rules and two Error-Notes rules apply to the transaction data identified in the row 410. The data-furnishing application applies the four data-processing rules to determine that the both Error-Notes rules and one Rule ID rule indicated an “F” decision. The data-furnishing application, however, also determines that another Rule ID rule generated an output indicating the “S” decision. Because the “S” decision of the Rule ID or Error-Notes category will override the furnish “F” decision of the other rule categories, the data-furnishing application assigns the “S” decision to the transaction data of the row 410.

In another example, the data-furnishing application determines that no Account-level rules apply to the transaction data identified in row 412, but also determines that two Rule ID rules and two Error-Notes rules apply to the transaction data identified in the row 412. The data-furnishing application applies the four data-processing rules to determine that the one Error-Notes rules and two Rule ID rules indicated an “F” decision. The data-furnishing application, however, also determines that another Error-Notes rule generated an output indicating the “S” decision. Because the “S” decision of the Rule ID or Error-Notes category will override the furnish “F” decision of the other rule categories, the data-furnishing application assigns the “S” decision to the transaction data of the row 412.

Additionally or alternatively, the data-furnishing application can maintain initial “F” decision after an agent reviews the transaction data initially identified as the “S” decision. For example, row 414 of the decision matrix 400 includes a final “F” decision, after the Rule ID rule initially indicated an “S” decision for the corresponding transaction data. The agent intervention for certain suppress decision can further facilitate accurate reporting of transaction data to data-collection agencies.

### B. Process for Applying Hierarchical Data-Processing Rules to Transaction Data

As described herein, the data-furnishing application can apply the plurality of data-processing rules to the transaction data by determining whether the plurality of data-processing rules include one or more data-processing rules associated with the third rule category (e.g., the Account Level category). If the one or more data-processing rules exist, the data-furnishing application applies the one or more data-processing rules prior while disregarding the remaining data-processing rules of the plurality of data-processing rules. Conversely, if it is determined that the plurality of data-processing rules do not include the one or more data-processing rules of the third rule category, the data-furnishing application can identify if rules associated with other rule categories exist for determining whether to suppress or furnish the first transaction data to the other entity. Applying the data-processing rules of the account-level category and disregarding rules of other rule categories can increase the efficiency of data-furnishing process by disregarding the other rules that would eventually be overridden.

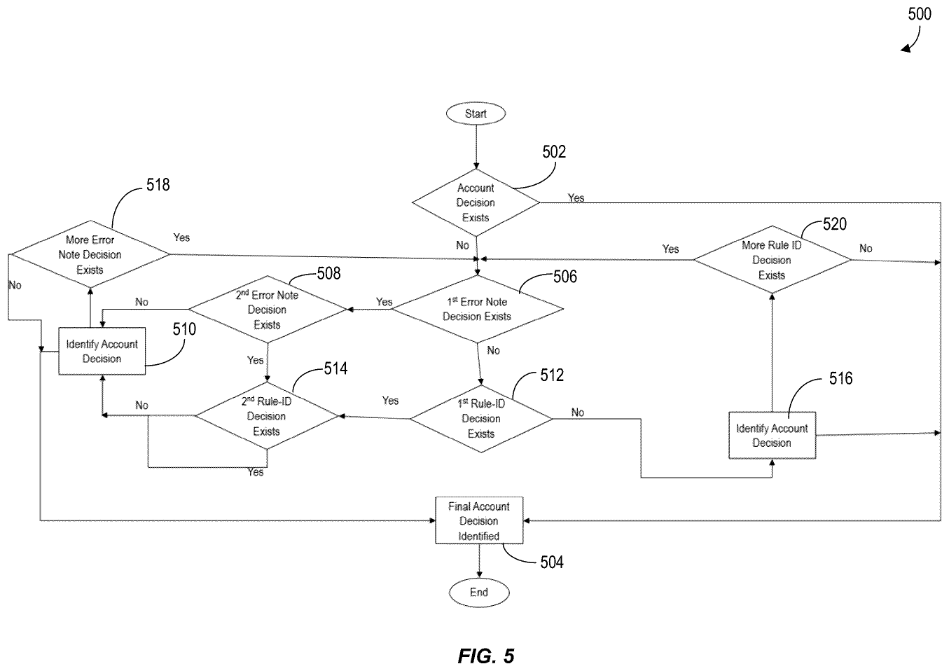

FIG. 5 illustrates a process 500 for applying hierarchical data-processing rules to transaction data, in accordance with some embodiments. The process 500 begins when a data-furnishing application (e.g., the data-furnishing application 102 of FIG. 1) accesses a transaction data of a user and determines whether an Account Level rule (e.g., a rule associated with a third rule category) applicable to the transaction data exists. If the Account Level rule exists (“Yes” path from the step 502), the data-furnishing application identifies a final decision for the transaction data (step 504). In this instance, the final decision can be based on an output generated by applying the Account Level rule to the transaction data.

If the Account Level rule does not exist (“No” path from the step 502), the data-furnishing application determines whether a first Error-Note rule (e.g., a rule associated with a second rule category) applicable to the transaction data exists (step 506). If the first Error-Note rule exists (“Yes” path from the step 506), the data-furnishing application continues to determine whether a second Error-Note rule applicable to the transaction data exists (step 508). If the second Error-Note rule does not exist (“No” path from the step 508), the data-furnishing application can identify a decision for the transaction data (step 510), which can be used to determine the final decision for the transaction data (step 504).

In some instances, if the first Error-Note rule does not exist (“No” path from the step 506), the data-furnishing application determines whether a first Rule ID rule (e.g., a rule associated with a first rule category) applicable to the transaction data exists (step 512). If the first Rule ID rule exists (“Yes” path from the step 512), the data-furnishing application continues to determine whether a second Rule ID rule applicable to the transaction data exists (step 514). In some instances, step 514 is performed if the data-furnishing application determines that the second Error-Note rule exists (“Yes” path from the step 508). Based on the outcome from the step 514, the data-furnishing application can determine whether to furnish or suppress the transaction data based on outputs generated by applying the Rule ID rules and the Error-Note rules (step 510), which can be used to determine the final decision for the transaction data (step 504).

If no Rule ID rule or Error-Note rule exists (“No” path from the step 512), the data-furnishing application determines that the transaction data is to be furnished to another entity (step 516). Such “Furnish” decision is based on a lack of output from applying the data-processing rules, as no applicable data-processing rules exist.

In some instances, the data-furnishing application determines whether additional Error-Note rules or Rule ID rules exist (steps 518 and 520). If there are additional Error-Note Rules (“Yes” path from the step 518 or step 520), the data-furnishing application may return and repeat the steps 506-516 to determine whether to furnish or suppress the transaction data.

### III. Example of a Computing Environment

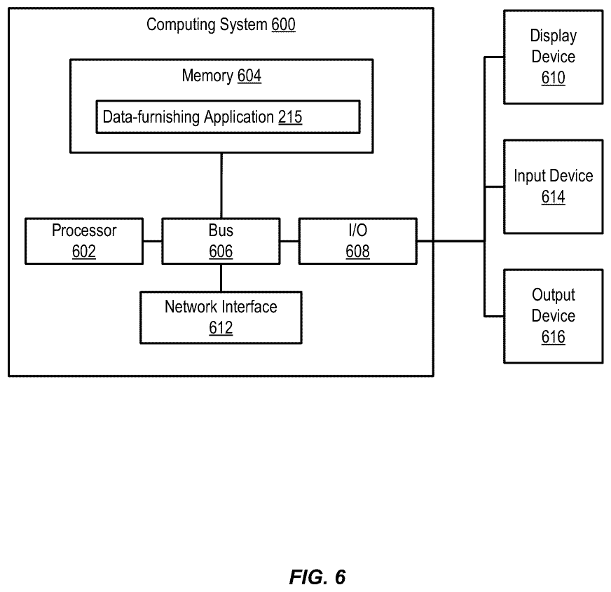

Any suitable computing system or group of computing systems can be used for performing the operations described herein. For example, FIG. 6 depicts a computing system 600 that can implement any of the computing systems or environments discussed above. In some embodiments, the computing system 600 includes a processing device 602 that executes the data-furnishing application 102, a memory that stores various data computed or used by the data-furnishing application 102, an input device 614 (e.g., a mouse, a stylus, a touchpad, a touchscreen), and an output device 616 that presents output to a user. For illustrative purposes, FIG. 6 depicts a single computing system on which the data-furnishing application 102 is executed, and the input device 614 and output device 616 are present. But these applications, datasets, and devices can be stored or included across different computing systems having devices similar to the devices depicted in FIG. 6.

The example of FIG. 6 includes a processing device 602 communicatively coupled to one or more memory devices 604. The processing device 602 executes computer-executable program code stored in a memory device 604, accesses information stored in the memory device 604, or both. Examples of the processing device 602 include a microprocessor, an application-specific integrated circuit (“ASIC”), a field-programmable gate array (“FPGA”), or any other suitable processing device. The processing device 602 can include any number of processing devices, including a single processing device.

The memory device 604 includes any suitable non-transitory, computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 600 may also include a number of external or internal devices, such as a display device 610, or other input or output devices. For example, the computing system 600 is shown with one or more input/output (“I/O”) interfaces 608. An I/O interface 608 can receive input from input devices or provide output to output devices. One or more buses 606 are also included in the computing system 600. Each bus 606 communicatively couples one or more components of the computing system 600 to each other or to an external component.

The computing system 600 executes program code that configures the processing device 602 to perform one or more of the operations described herein. The program code includes, for example, code implementing the data-furnishing application 102 or other suitable applications that perform one or more operations described herein. The program code may be resident in the memory device 604 or any suitable computer-readable medium and may be executed by the processing device 602 or any other suitable processor. In some embodiments, all modules in the data-furnishing application 102 are stored in the memory device 604, as depicted in FIG. 6. In additional or alternative embodiments, one or more of these modules from the data-furnishing application 102 are stored in different memory devices of different computing systems.

In some embodiments, the computing system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computing system 600 is able to communicate with one or more other computing devices (e.g., a computing device that receives inputs for data-furnishing application 102 or displays outputs of the data-furnishing application 102) via a data network using the network interface device 612.

An input device 614 can include any device or group of devices suitable for receiving visual, auditory, or other suitable input that controls or affects the operations of the processing device 602. Non-limiting examples of the input device 614 include a touchscreen, stylus, a mouse, a keyboard, a microphone, a separate mobile computing device, etc. An output device 616 can include any device or group of devices suitable for providing visual, auditory, or other suitable sensory output. Non-limiting examples of the output device 616 include a touchscreen, a monitor, a separate mobile computing device, etc.

Although FIG. 6 depicts the input device 614 and the output device 616 as being local to the computing device that executes the data-furnishing application 102, other implementations are possible. For instance, in some embodiments, one or more of the input device 614 and the output device 616 include a remote client-computing device that communicates with the computing system 600 via the network interface device 612 using one or more data networks described herein.

### IV. General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method comprising:
accessing first transaction data of a system-of-record (SOR) file associated with an entity, wherein the first transaction data is associated with a first account of a first user;
applying a plurality of data-processing rules to the first transaction data to determine whether the first transaction data is to be suppressed or furnished to another entity, wherein each data-processing rule of the plurality of data-processing rules is associated with a rule condition and a particular rule category of a set of rule categories, wherein the set of rule categories includes:
a first rule category configured to be applicable to a plurality of accounts associated with the entity;
a second rule category configured to be applicable to a subset of accounts of the plurality of accounts; and
a third rule category configured to be applicable to a single account of the plurality of accounts, wherein an output generated by applying a data-processing rule of the third rule category overrides other outputs generated by applying other data-processing rules of the first and second rule categories;
determining, based on a set of outputs generated by applying the plurality of data-processing rules, that the first transaction data violates a first condition associated with a first data-processing rule of the third rule category while satisfying a second condition associated with a second data-processing rule of the second rule category;
in response to determining that the first transaction data violates the first condition of the first data-processing rule, generating a first report that excludes the first transaction data; and
outputting the first report.

2. The method of claim 1, further comprising:
accessing second transaction data of the SOR file, wherein the second transaction data is associated with a second account of a second user;
applying the plurality of data-processing rules to the second transaction data to determine whether the second transaction data is to be suppressed or furnished to the other entity;
determining, based on a set of outputs generated by applying the plurality of data-processing rules, that the second transaction data satisfies the first condition of the first data-processing rule while violating the second condition of the second data-processing rule and a third condition of a third data-processing rule of a first rule category;
in response to determining that the second transaction data satisfies the first condition of the first data-processing rule, generating a second report that includes the second transaction data; and
outputting the second report.

3. The method of claim 1, further comprising:
accessing third transaction data of the SOR file, wherein the third transaction data is associated with a third account of a third user;
applying the plurality of data-processing rules to the third transaction data to determine whether the third transaction data is to be suppressed or furnished to the other entity;
determining, based on a set of outputs generated by applying the plurality of data-processing rules, that the third transaction data satisfies the second condition of the second data-processing rule while violating a third condition associated with a third data-processing rule of a first rule category;
in response to determining that the third transaction data violates the third data-processing rule, generating a third report that excludes the third transaction data; and
outputting the third report.

4. The method of claim 1, wherein the applying the plurality of data-processing rules to the first transaction data includes determining whether the plurality of data-processing rules include one or more data-processing rules associated with the third rule category.

5. The method of claim 4, further comprising
determining that the plurality of data-processing rules include the one or more data-processing rules; and
applying the one or more data-processing rules prior while disregarding the remaining data-processing rules of the plurality of data-processing rules.

6. The method of claim 4, further comprising:
determining that the plurality of data-processing rules do not include the one or more data-processing rules and include data-processing rules associated with the first and second rule categories;
accessing a decision matrix that represents the plurality of data-processing rules; and
iteratively applying each of the plurality of data-processing rules of the decision matrix to the first transaction data to determine whether to suppress or furnish the first transaction data to the other entity.

7. The method of claim 1, wherein the other entity is a data-collection agency.

8. A system comprising one or more processors and at least one memory, the at least one memory storing instructions which, when executed by the one or more processors, cause the system to perform one or more operations comprising:
accessing first transaction data of a system-of-record (SOR) file associated with an entity, wherein the first transaction data is associated with a first account of a first user;
applying a plurality of data-processing rules to the first transaction data to determine whether the first transaction data is to be suppressed or furnished to another entity, wherein each data-processing rule of the plurality of data-processing rules is associated with a rule condition and a particular rule category of a set of rule categories, wherein the set of rule categories includes:
a first rule category configured to be applicable to a plurality of accounts associated with the entity;
a second rule category configured to be applicable to a subset of accounts of the plurality of accounts; and
a third rule category configured to be applicable to a single account of the plurality of accounts, wherein an output generated by applying a data-processing rule of the third rule category overrides other outputs generated by applying other data-processing rules of the first and second rule categories;
determining, based on a set of outputs generated by applying the plurality of data-processing rules, that the first transaction data violates a first condition associated with a first data-processing rule of the third rule category while satisfying a second condition associated with a second data-processing rule of the second rule category;
in response to determining that the first transaction data violates the first condition of the first data-processing rule, generating a first report that excludes the first transaction data; and
outputting the first report.

9. The system of claim 8, wherein the instructions further cause the system to perform one or more operations comprising:
accessing second transaction data of the SOR file, wherein the second transaction data is associated with a second account of a second user;
applying the plurality of data-processing rules to the second transaction data to determine whether the second transaction data is to be suppressed or furnished to the other entity;
determining, based on a set of outputs generated by applying the plurality of data-processing rules, that the second transaction data satisfies the first condition of the first data-processing rule while violating the second condition of the second data-processing rule and a third condition of a third data-processing rule of a first rule category;
in response to determining that the second transaction data satisfies the first condition of the first data-processing rule, generating a second report that includes the second transaction data; and
outputting the second report.

10. The system of claim 8, wherein the instructions further cause the system to perform one or more operations comprising:
accessing third transaction data of the SOR file, wherein the third transaction data is associated with a third account of a third user;
applying the plurality of data-processing rules to the third transaction data to determine whether the third transaction data is to be suppressed or furnished to the other entity;
determining, based on a set of outputs generated by applying the plurality of data-processing rules, that the third transaction data satisfies the second condition of the second data-processing rule while violating a third condition associated with a third data-processing rule of a first rule category;
in response to determining that the third transaction data violates the third data-processing rule, generating a third report that excludes the third transaction data; and
outputting the third report.

11. The system of claim 8, wherein the applying the plurality of data-processing rules to the first transaction data includes determining whether the plurality of data-processing rules include one or more data-processing rules associated with the third rule category.

12. The system of claim 11, wherein the instructions further cause the system to perform one or more operations comprising:
determining that the plurality of data-processing rules include the one or more data-processing rules; and
applying the one or more data-processing rules prior while disregarding the remaining data-processing rules of the plurality of data-processing rules.

13. The system of claim 11, wherein the instructions further cause the system to perform one or more operations comprising:
determining that the plurality of data-processing rules do not include the one or more data-processing rules and include data-processing rules associated with the first and second rule categories;
accessing a decision matrix that represents the plurality of data-processing rules; and
iteratively applying each of the plurality of data-processing rules of the decision matrix to the first transaction data to determine whether to suppress or furnish the first transaction data to the other entity.

14. The system of claim 8, wherein the other entity is a data-collection agency.

15. A non-transitory computer-readable medium comprising instructions which, when executed by one or more processors of a computing system, cause the computing system to perform one or more operations comprising:
accessing first transaction data of a system-of-record (SOR) file associated with an entity, wherein the first transaction data is associated with a first account of a first user;
applying a plurality of data-processing rules to the first transaction data to determine whether the first transaction data is to be suppressed or furnished to another entity, wherein each data-processing rule of the plurality of data-processing rules is associated with a rule condition and a particular rule category of a set of rule categories, wherein the set of rule categories includes:
a first rule category configured to be applicable to a plurality of accounts associated with the entity;
a second rule category configured to be applicable to a subset of accounts of the plurality of accounts; and
a third rule category configured to be applicable to a single account of the plurality of accounts, wherein an output generated by applying a data-processing rule of the third rule category overrides other outputs generated by applying other data-processing rules of the first and second rule categories;
determining, based on a set of outputs generated by applying the plurality of data-processing rules, that the first transaction data violates a first condition associated with a first data-processing rule of the third rule category while satisfying a second condition associated with a second data-processing rule of the second rule category;
in response to determining that the first transaction data violates the first condition of the first data-processing rule, generating a first report that excludes the first transaction data; and
outputting the first report.

16. The non-transitory computer-readable medium of claim 15, wherein the instructions further cause the system to perform one or more operations comprising:
accessing second transaction data of the SOR file, wherein the second transaction data is associated with a second account of a second user;
applying the plurality of data-processing rules to the second transaction data to determine whether the second transaction data is to be suppressed or furnished to the other entity;
determining, based on a set of outputs generated by applying the plurality of data-processing rules, that the second transaction data satisfies the first condition of the first data-processing rule while violating the second condition of the second data-processing rule and a third condition of a third data-processing rule of a first rule category;
in response to determining that the second transaction data satisfies the first condition of the first data-processing rule, generating a second report that includes the second transaction data; and
outputting the second report.

17. The non-transitory computer-readable medium of claim 15, wherein the instructions further cause the system to perform one or more operations comprising:
accessing third transaction data of the SOR file, wherein the third transaction data is associated with a third account of a third user;
applying the plurality of data-processing rules to the third transaction data to determine whether the third transaction data is to be suppressed or furnished to the other entity;
determining, based on a set of outputs generated by applying the plurality of data-processing rules, that the third transaction data satisfies the second condition of the second data-processing rule while violating a third condition associated with a third data-processing rule of a first rule category;
in response to determining that the third transaction data violates the third data-processing rule, generating a third report that excludes the third transaction data; and
outputting the third report.

18. The non-transitory computer-readable medium of claim 15, wherein the applying the plurality of data-processing rules to the first transaction data includes determining whether the plurality of data-processing rules include one or more data-processing rules associated with the third rule category.

19. The non-transitory computer-readable medium of claim 18, wherein the instructions further cause the system to perform one or more operations comprising:
determining that the plurality of data-processing rules include the one or more data-processing rules; and
applying the one or more data-processing rules prior while disregarding the remaining data-processing rules of the plurality of data-processing rules.

20. The non-transitory computer-readable medium of claim 18, wherein the instructions further cause the system to perform one or more operations comprising:
determining that the plurality of data-processing rules do not include the one or more data-processing rules and include data-processing rules associated with the first and second rule categories;
accessing a decision matrix that represents the plurality of data-processing rules; and
iteratively applying each of the plurality of data-processing rules of the decision matrix to the first transaction data to determine whether to suppress or furnish the first transaction data to the other entity.
